(19) United States
(12) Patent Application Publication
(10) Pub. No.: US 2009/0296263 A1
(43) Pub. Date: Dec. 3, 2009

(54) INFORMATION STORAGE APPARATUS

(75) Inventors: Takashi Kida, Kawasaki (JP); Susumu Yoshida, Kawasaki (JP); Isamu Tomita, Kawasaki (JP); Takeyori Hara, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/408,682

(22) Filed: Mar. 21, 2009

(30) Foreign Application Priority Data
Jun. 2, 2008 (JP) 2008-144516

(51) Int. Cl. G11B 21/02

(52) U.S. Cl. 360/75; G9B/21.003

(57) ABSTRACT

An information storage apparatus includes a disc-shaped recording medium in which control marks aligned in a predetermined rule are recorded, a head contacting or approaching a recording medium surface to reproduce/record information of the recording medium and detecting the control marks, a head driving section holding the head to move the head in a direction of coming near or away to/from a recording medium rotation center, a driving force control section controlling a driving force for head driving section, a driving time control section controlling a driving time for the head driving section using an interval of the detection of the plural control marks as a time unit, and a driving force correcting section obtaining a difference between an ideal interval based on the rule of the control marks and an actual interval of the control marks to correct the control of the driving force based on the difference.

### CROSS-REFERENCE TO RELATED APPLICATION(S)

This application is based upon and claims the benefit of priority of the prior Japanese Laid-open Patent No. 2008-144516, filed on Jun. 2, 2008, the entire contents of which are incorporated herein by reference.

### FIELD

The embodiments discussed herein are related to an information storage apparatus that detection of a control mark is performed by a head by rotating a recording medium in which multiple control marks aligned according to a predetermined rule are recorded, and a driving time of a head is controlled using a detection interval of a control mark which follows rotation of a recording medium as a unit of time.

### BACKGROUND

Recently, as a computer technique develops, a technique for a peripheral apparatus which is externally connected to an apparatus built in a computer or a computer rapidly develops.

As one of such techniques, known is an information storage apparatus that has a flat storage medium such as a magnetic disc and writes information on the storage medium to store information.

Among information storage apparatuses, there is an information storage apparatus that records/reproduces (accesses) information on/from a storage medium by moving a head which serves to record/reproduce information on/from the storage medium-on a storage medium while a disc-shaped storage medium is rotating. A hard disc drive (HDD) is a representative example of such an information storage apparatus. In an information storage apparatus which accesses a storage medium using a head, multiple tracks which go around a disc center of a storage medium are formed on a storage medium in a radial direction. In such a storage medium, a data area that information (hereinafter, simply referred to as “data”) dealt by a user is written or read out and a servo area that stores information (hereinafter, simply referred to as “position information”) which is used to determine a position of a head such as an address are alternately formed on each track, and each data area is identified by position information which is stored in a servo area and represents a position of a radial direction and a position of a circumferential direction. A head reads position information from a servo area, so that a head position when reading is demodulated, and a head position is determined to a desired position based on a demodulation position of the head. At this time, in a storage medium, if head position determination is accurately performed, an information reading mistake or an information writing mistake is reduced and, thus it is very important in realizing an access with high accuracy. Therefore, a head position determination control has been conventionally performed according to a demodulated head position so that head position determination can be accurately performed (for example, Japanese Laid-Open Publication Nos. H11-353831, H10-507027, and 2006-12350).

Here, head position determination, which is performed in a convention HDD, will be described below.

FIG. 1 is a control block diagram illustrating a head position determination control which is performed in a conventional HDD.

A HDD includes a voice coil motor which moves a head in a radial direction of a magnetic disc, and the voice coil motor is controlled by an electric current which is driven to flow through the voice coil motor. The head moves in a radial direction of a magnetic disc according to a control current which is driven to flow through the voice coil motor, and sequentially approaches multiple servo areas aligned in a circumferential direction of a magnetic disc with rotation of a magnetic disc. At this time, the head reads position information from a servo area which it approaches, so that a head position when reading is demodulated. In FIG. 1, both the head and the voice coil motor are collectively indicated as a plant P, and it is schematically depicted in this figure that the plant P outputs a demodulation position when a control value (a value of a control current) is input.

In the HDD, whenever the head approaches the servo area and so a head position is demodulated, an adjustment of a control value is performed based on a demodulation position. As will be described in detail later, since the servo area is disposed on a magnetic disc such that the head and the servo area regularly encounter each other as the magnetic disc rotates, the adjustment of a control value described above is also regularly performed. As a result, in a servo area that the head approaches next, a head position with respect to a radial direction of a magnetic disc becomes closer to a preferable head position (desired head position) for realizing an access with high accuracy. In FIG. 1, in order to carry an adjustment of the control value, a logical value acquiring section 5701, an error computing section 5702, a first estimated error coefficient section 5703, a second estimated error coefficient section 5704, a position adding section 5705, a speed adding section 5706, a position coefficient section 5707, a speed coefficient section 5708, and a control value computation adding section 5709_1 are provided.

A control value of the plant P is inputted to the logical value acquiring section 5701. Every time demodulation of a head position is performed, the demodulated position is inputted to and stored in the logical value acquiring section 5701. When the control value of the plant P and the demodulated position under the control value are inputted, the logical value acquiring section 5701 reads a demodulated position of the head of one time before and a demodulated position of the head of two times before and computes an average head speed between demodulation of the head of two times before and demodulation of the head of one time before by dividing a difference between the demodulated position of the head of one time before and the demodulated position of the head of two times before by a predetermined time corresponding to a time interval of a demodulation operation of a head position. Next, the logical value acquiring section 5701 approximately solves an equation of motion for the head position under an inputted control value, under a condition that an initial head position with respect to the radial direction of a magnetic disc is the demodulated position of the head of one time before, and an initial head speed with respect to the radial direction of the magnetic disc is the average speed described above. The logical value acquiring section 5701 obtains a head position and a head speed after the predetermined time described above lapses based on a result of solving the equation. The head position and the head speed thus obtained are a logical head position (logical position) and a logical head speed (logical speed) in a servo area for which the demodulated position is obtained this time.

The error computing section 5702 obtains a difference (error) between the demodulated position outputted from the plant P and a logical position in a servo area where the demodulated position is obtained. The first error coefficient section 5703 and the second error coefficient section 5704 multiply the error computed in the error computing section 5702 by coefficients according to the error, respectively. The coefficients to be multiplied according to a value of the error is determined in advance in the first error coefficient section 5703 and the second error coefficient section 5704 from a viewpoint of setting the head position to a desired head position, and the “coefficient according to the error” is determined according to the determination.

The position adding section 5705 adds the error multiplied by the coefficient in the first error coefficient section 5703 to the logical position obtained in the logical value acquiring section 5701. Here, a value obtained in the position adding section 5705 is an estimated value (estimated position) of the head position of a next servo area that the head approaches after the servo area in which demodulation of the head position is previously performed. The position coefficient section 5707 multiplies the estimated position by a predetermined coefficient.

The speed adding section 5706 adds the error which is multiplied by the coefficient in the second error coefficient section 5704 to the logical speed obtained in the logical value acquiring section 5701. Here, the value obtained in the speed adding section 5706 becomes an estimated value (estimated speed) of the head speed of a next servo area that the head approaches after a servo area in which demodulation of a head position is previously performed. The speed coefficient section 5708 multiplies the estimated speed by a predetermined coefficient.

Commonly, an equation of motion for the head position is a linear relation of a control value of the plant P (control current of the voice coil motor), a head position, a head speed, and a head acceleration, and becomes an equation that a control value of the plant P is expressed by the head position and the head speed if a head acceleration is ignored.

The predetermined coefficient by which the estimated head position is multiplied in the position coefficient section 5707 described above and the predetermined coefficient by which the estimate head speed is multiplied in the speed coefficient section 5708 described above are a coefficient of the head position and a coefficient of the head speed in the equation that the control value of the plant P is expressed by the head position and the head speed. The control value computation adding section 5709_1 obtains a control value corresponding to the estimated head position and the estimated head speed by obtaining a sum of the estimated value of the head position multiplied by the coefficient in the position coefficient section 5707 and the estimated value of the head speed multiplied by the coefficient in the speed coefficient section 5708. This control value is employed as a new control value for approaching the head position (demodulated position) in a servo area that the head approaches next time to a desired head position.

Updating of the control value described above is repeated so that the head position gradually becomes closer to a desired head position.

More strictly, in the equation of motion about the head position, there exists external forces which are not in proportion to the head position or the head speed such as a force caused by an air flow generated as a magnetic disc rotates. Regarding such external forces, how large magnitudes of the forces are grasped in advance and are listed in a table form. In a conventional HDD, influences of such external forces are eliminated by adjusting the control value with reference to the table. The control block diagram of FIG. 1 illustrates a method of adjusting the control value to determine the head position under an assumption that the influences of the external forces are eliminated and thus do not exist.

In a servo area formed on a magnetic disc, a signal which represents start of the servo area, which is called a servo mark, is also recorded. Servo areas formed on a magnetic disc are generally aligned at a constant interval in a circumferential direction of the magnetic disc. Accordingly, as the magnetic disc rotates at a predetermined speed, a head ideally reads the servo marks in the servo areas at a predetermined time interval. In a conventional HDD, the time interval at this moment is used as a reference of a unit of time, and this constant time interval is used as the predetermined time described in the logical value acquiring section 5701.

However, in a manufacturing process of a HDD, a magnetic disc may be installed in the HDD in an aspect that a center of the magnetic disc is slightly shifted from a rotation center in a mechanism which rotates the magnetic disc. In this instance, a time interval (hereinafter, referred to “servo frame time interval”) that a servo mark is read is deviated from the above described constant time interval (hereinafter, referred to “normal servo frame time interval”) and varies depending on a position on the magnetic disc. As a result, there occurs a problem in that a unit of time, which is used as a reference in determining a head position, varies depending on a position on the magnetic disc.

FIG. 2 illustrates a head moving distance of the head in a situation that the servo frame time interval is normal, and FIGS. 3A and 3B illustrate a moving distance of the head in a situation that the servo frame time interval is deviated from the normal servo frame time interval.

FIG. 2 and FIGS. 3A and 3B illustrate a change of a distance in which the head moves while the head encounters a predetermined number (in this example, four) in a situation that the head moves relatively to the magnetic disc at a predetermined speed V. FIG. 2 illustrates a change of a moving distance of the head at a position where, in the magnetic disc, the servo frame time interval is equal to the normal servo frame time interval. FIG. 3A illustrates a change of a moving distance of the head at a position where, in the magnetic disc, the servo frame time interval is smaller than the normal servo frame time interval, and FIG. 3B illustrates a change of a moving distance of the head at a position where the servo frame time interval is larger than the normal servo frame time interval.

When the servo frame time interval is used as a reference of time, a time in which the head moves is a time corresponding to three of the servo frame time intervals in FIG. 2 and FIGS. 3A and 3B, the length of this time is dealt same in any case of FIG. 2 and FIGS. 3A and 3B in a position determination control of the head.

FIG. 2 illustrates that the head moves a distance L₀ in the time corresponding to three of the servo frame time intervals, and the distance L₀ is the normal moving distance which corresponds to the time corresponding to three of the servo frame time intervals. FIG. 3A illustrates that the head moves a distance L₁ during a time corresponding to three of servo frame time intervals, and the distance L₁ is shorter than the distance L₀ of FIG. 2 because the servo frame time interval of FIG. 3A is shorter than the servo frame time interval of FIG. 2. FIG. 3B illustrates that the head moves a distance L₂ during a time corresponding to three of servo frame time intervals, and the distance L₂ is longer than the distance L₀ of FIG. 2 because the servo frame time interval of FIG. 3B is shorter than the servo frame time interval of FIG. 2.

As illustrated in FIGS. 3A and 3B, in a case where such a magnetic disc that a servo frame time interval is different depending on a position is employed in a conventional HDD, an actual moving distance of the head (for example, distance L₁ or distance L₂) hardly agrees with a logically estimated moving distance of the head (for example, the distance L₀) and thus varies depending on a position on the magnetic disc. As a result, even though the control described above is performed, an error between the logical position and the demodulated position is difficult to be small, and so it takes a time that a head position comes to a desired position.

Recently, in the HDD industry, it is strongly required to reduce a time for reproducing and recording information and to position a head with high accuracy in a short time. Deviation in a servo frame time interval is a problem to be resolved in performing head position determination with high accuracy in a short time.

Hereinbefore, a HDD has been described as an example, but the problem described above may occur in all of information storage apparatuses in which a detection interval of a control mark when a storage medium having multiple control marks aligned according to a predetermined rule is rotated is used as a unit of time.

### SUMMARY

In view of the foregoing, the present invention provides, an information storage apparatus in which head position determination can be performed with high accuracy in a short time.

According to a basic aspect of the information storage apparatus, an information storage apparatus includes:

a recording medium which has a disc shape and in which information is recorded and a plurality of control marks are recorded, the plurality of control marks being aligned in a predetermined rule;

a medium driving section that rotates the recording medium;

a head that contacts or approaches a surface of the recording medium to perform reproducing of information and/or recording of information from/to the recording medium and that detects the a plurality of control marks;

a head driving section that holds the head and moves the head along the surface of the recording medium in a direction including a directional component of coming near or coming away to/from a rotation center of the recording medium;

a driving force control section that controls a driving force for the head driving section;

a driving time control section that controls a driving time for the head driving section using as a unit of time an interval of the detection of the plurality control marks by the head as the recording medium is rotated by the medium driving section; and

a driving force correcting section that obtains a difference between an ideal interval of the control mark based on the rule and an actual interval of the control mark, and that corrects the control of the driving force controlled by the driving force control section based on the difference.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a control block diagram illustrating a positioning control of a head performed in a conventional HDD;

FIG. 2 illustrates a moving distance of a head in a situation in which a servo frame time interval is normal;

FIGS. 3A and 3B illustrate moving distance of a head in a situation in which the servo frame time interval is deviated from a normal servo frame time interval;

FIG. 4 illustrates a hard disc drive (HDD) as an example of an information storage apparatus according to an embodiment of the present invention;

FIG. 5 illustrates a control board;

FIG. 6 is a control block diagram illustrating a positioning control of the head which is performed in the HDD of FIG. 4;

FIG. 7 is a control block diagram illustrating a positioning control of a head which is performed in a HDD according to another embodiment of the present invention;

FIGS. 8A and 8B illustrate moving distances of the head in a situation in which the servo frame time interval is deviated from a normal frame time interval in the HDD according to the another embodiment of the present invention;

FIG. 9 illustrates an access time when a control for correcting an influence of deviation of the servo frame time interval is performed and an access time when such control is not performed; and

FIGS. 10A and 10B illustrate head positions along time while head positioning is performed (during a seek time).

### DESCRIPTION OF THE EMBODIMENTS

Embodiments of the information storage apparatus described above according to the basic aspect of the present invention will be described below in detail with reference to the accompanying drawings.

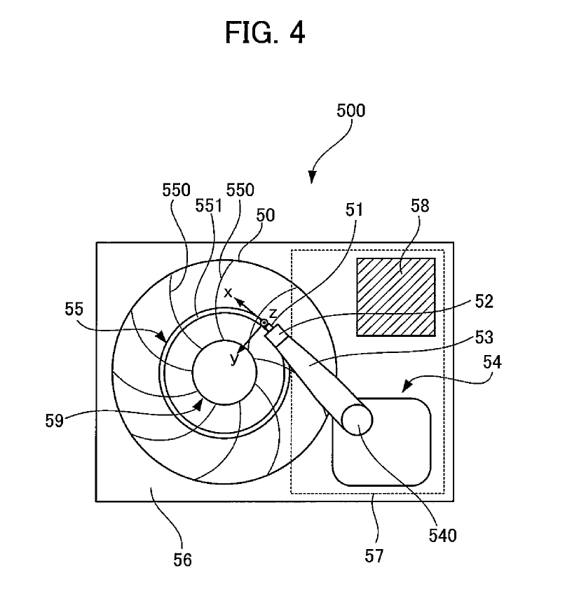

FIG. 4 illustrates a hard disc drive (HDD) 500 as an embodiment of the information storage apparatus.

In the HDD 500 illustrated in FIG. 4, a voice coil which is a movable coil and a voice coil motor 54 incorporating a permanent magnet which applies a predetermined magnetic field to the voice coil, are provided. The voice coil motor 54 moves the voice coil as an electric current is flown to the voice coil, and a rotation driving force around a shaft 540 is generated by the movement of the voice coil. An arm 53 receives the rotation driving force of the voice coil motor 54 to rotate around the shaft 540. A slider 52 as a support member called a gimbals is attached to an end of the arm 53, and a head 51 is attached to an end of the slider 52.

The head 51 serves to read information from a magnetic disc 50 or to recording information to the magnetic disc. When reading or record information, the arm 53 is driven by the voice coil motor 54 to rotate about the voice coil motor 54, so that the head 51 moves in a radial direction of the magnetic disc to be positioned to a desirable position (desirable head position) for achieving an access with high accuracy with respect to the radial direction of the magnetic disc. Here, the voice coil motor 54 corresponds to one example of the head driving section in the basic aspect described above.

The head 51 positioned at a desired position is held above a surface of the disc-shaped magnetic disc 50 in a small distance, and in this state, the head 51 reads information from the magnetic disc 50 or records information to the magnetic disc 50. In FIG. 4, the head 51 is expressed in a xyz rectangular coordinate system in which a position of the head 51 is defined as a zero point, the direction toward a center of the magnetic disc 103 is defined as a y axis and the direction of the normal, perpendicular to FIG. 4 is defined as a z axis.

Multiple zonal tracks which go around the center of the disk are formed on a surface of the disc-shaped magnetic disc 50 in the radial direction. FIG. 4 illustrates one track 55 among the multiple tracks. Also, multiple servo areas 550 which extend between a rotation center side of the disc 50 and a circumference side of the disc 50, are provided on the surface of the disc-shaped magnetic disc 50 as illustrated in FIG. 4. The servo areas 550 are areas which store information for positioning the head 51, and position information (address information) which represents a position of a radial direction and a position of a circumferential direction are recorded. A signal which indicates a start of the servo area, which is called a servo mark, is also recorded in the servo areas 550. The servo areas 550 are aligned along the tracks 55 at a constant interval. That is, an angle interval between the servo areas 550 viewed from the rotation center of the magnetic disc 50 is constant. Each of the servo areas 550 has a curved shape tracing a gentle arc as illustrated in FIG. 4, and the curved shape follows a track of the head 21 when the head 51 moves above the magnetic disc by the rotation driving of the voice coil motor 54.

The magnetic disc 50 receives the rotation driving force of a spindle motor 59 to rotate at a predetermined speed in a surface of FIG. 4 about an approximate disc center as a rotation center. Here, if the disc center of the magnetic disc 50 coincides the rotation center, due to the curved shape of the servo areas 550, the head 51 approaches each servo area 550 at a constant time interval when it moves in a radial direction as well as when the head 51 stops above the magnetic disc 50. Here, the spindle motor 59 corresponds to one example of the medium driving section in the basic aspect described above.

In the track 55 in FIG. 4, an area between the two servo areas 550 is an area called a sector, and a data sector 551 is a data area used for reading and recording of information (hereinafter, simply referred to as “data”) dealt by a user.

In the servo areas 550 or the data area, magnetizations are aligned in a positive direction or a negative direction of a z axis in FIG. 4, and one-bit information is represented such that two values of “0” and “1” are expressed by the two directions. The head 51 disposed near a surface of the magnetic disc 50 sequentially approaches the magnetizations aligned along the track 55 of the magnetic disc 50 which is rotating.

The head 51 includes two elements: a recording element (not illustrated in FIG. 4) which writes information to the magnetic disc 50; and a reproducing element (not illustrated in FIG. 4) which reads information from the magnetic disc 50. The reproducing element has a magneto-resistance effect film in which an electrical resistance value changes according to a direction of an applied electric field. When reproducing data or position information or detecting a servo mark, the reproducing element takes information represented in a direction of the magnetization by detecting that a value of an electric current flowing through the magneto-resistance effect film changes according to a direction of an electric field generated by the magnetization. A signal, which represents the change of an electric current, is a reproducing signal which represents the taken information, and the reproducing signal is outputted to a head amplifier 58. The recording element has a coil and a pole piece which function as an electromagnet. When recording data, an electrical recording signal in which data is represented by a bit value is inputted through the head amplifier 58 to the recording element of the head 51 approaching the magnetic disc 50, and the recording element applies an electric current of a direction according to the bit value of the recording signal to the coil. A magnetic field generated in the coil by the electric current passes through the magnetic piece and is applied to the magnetizations on the magnetic disc, so that directions of the magnetizations are aligned to a direction according to a bit value of the recording signal. Accordingly, data contained in the recording signal is recorded in a form of a magnetization direction.

The head 51 sequentially approaches the data sector 551 and the servo area 550 which are aligned in the circumferential direction, as the magnetic disc 50 rotates and the head 51 performs reading of a servo mark or position information, and as will be described later, based on the reading result, the head 51 is positioned at a position of the radial direction of the magnetic disc 50 at which position a desired data sector 551 exists. After the head 51 is positioned, when the head 51 approaches the desired data sector 551 by rotation of the magnetic disc 50, reproducing/recording of data is performed.

Sections directly related to recording and reproducing of information such as the voice coil motor 54, the arm 53, the slider 52, the head 51, and the head amplifier 58 are accommodated in a base 56 together with the magnetic disc 50, and FIG. 4 illustrates the state inside the base 56. A control board 57 having a control circuit which controls driving of the voice coil motor 54 or access by the head 51 is provided on a back surface of the base 56, and in FIG. 4, the control board 57 is expressed by a dotted line. Also, in the HDD 500, sections on the front side of the base 56 and the control board 57 on the back side of the base 56 are accommodated in a chassis which is not illustrated in FIG. 4. Each of the sections described above are electrically connected to the control board 57 through a mechanism which is not illustrated in FIG. 4, and the above-described recording signal inputted to the head 51 or the above-described reproducing signal produced in the head 51 is processed in the control board 57 through the head amplifier 58.

Next, the control board 57 is described below.

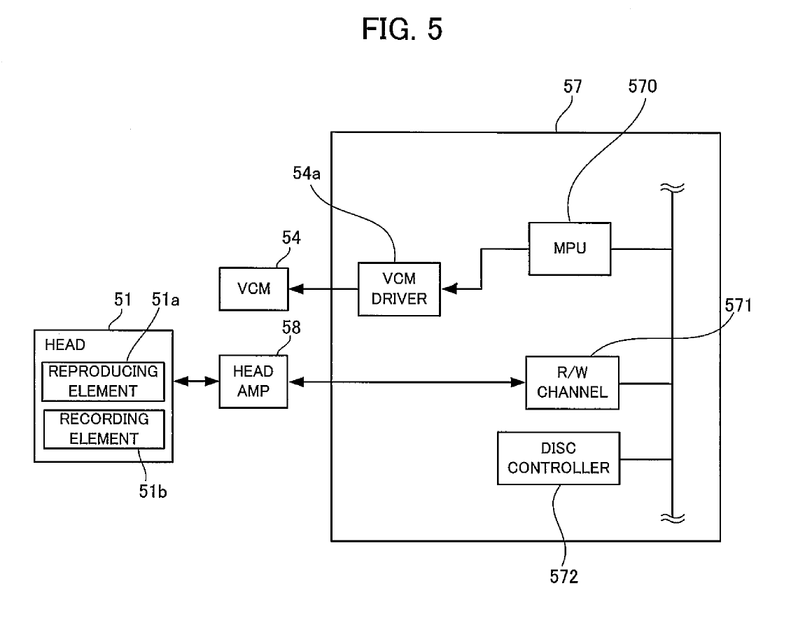

FIG. 5 illustrates a configuration of the control board 57.

A Micro Processing Unit (MPU) 570 which controls the voice coil motor (VCM) 54 through a voice coil motor (VCM) driver 54a and a disc controller 572 which controls recording/reproducing (access) of data by the head 51 on/from the magnetic disc 55 in FIG. 4 are arranged in the control board 57. An R/W channel 571, which performs signal processing for a reproducing signal or a recording signal, is arranged in the control board 57.

When recording data, a recording signal is inputted to the R/W channel 571 from an external apparatus connected to the HDD 500 such as a computer through the disc controller 572, and various signal processing such as analog-digital conversion is performed in the R/W channel 571. The recording signal which has undergone signal processing is amplified in the head amplifier 58 and is then inputted to a recording element 51b in the head 51, so that recording of data on the magnetic disc 50 is performed as described above.

When reproducing data or reproducing position information, as described above, a reproducing signal is generated in a reproducing element 51a of the head 51, and the reproducing signal is amplified in the head amplifier 58, is then inputted to the R/W channel 571 and is subject to various signal processing.

Here, the reproducing signal of data is transmitted to the disc controller 572 after signal processing in the R/W channel 571 and is transmitted from the disc controller 572 to an external apparatus (such as a computer) connected to the HDD 500.

The reproducing signal of position information is inputted to the MPU 570 after signal processing in the R/W channel 571. The MPU 570 receives from the disc controller 572 an instruction of an execution of positioning of the head 51 and performs control for positioning of the head 51 by controlling the voice coil motor 54 through the voice coil motor (VCM) driver 54a based on inputted position information and a reproducing signal of correction information. Here, in the HDD 500, a time interval when the head 51 sequentially approaches the multiple servo areas 550 is a unit of time in the head positioning, and the control of positioning of the head 51 is performed under the unit of time. Here, the MPU 570 corresponds to one example which serves as both the driving force control section and the driving time control section in the basic aspect described above.

Commonly, in the HDD, since the servo areas formed on the magnetic disc are aligned at a constant interval in a circumferential direction of the magnetic disc, when the magnetic disc rotates at a predetermined constant speed, the servo marks of the servo areas are ideally read at a constant time interval, and the time interval at this moment is used as a reference of a unit of time.

However, in a HDD manufacturing process, the magnetic disc may be installed in the HDD in a state in which a center of the magnetic disc is shifted from a rotation center of a mechanism which rotates the magnetic disc. In this state, a time interval (hereinafter, servo frame time interval) in which the servo mark is read is deviated from a normal servo frame time interval and thus varies depending on a position on the magnetic disc. As a result, there occurs a matter in which a unit of time, which is used as a reference in head positioning, varies depending on a position on the magnetic disc.

In the head positioning control performed in the HDD 550, control of the voice coil motor 54 is performed in such a manner that an influence of the deviation from the servo frame time interval is corrected. The head positioning control performed in the HDD 550 is described below.

The head positioning control is performed through controlling a control current which is flown to the voice coil motor 54. In detail, whenever the head 51 approaches the servo areas 550 and performs detecting of the service marks or reproducing of position information (hereinafter, “demodulation of position”), an adjustment of a control value is performed by a method which will be described below based on the position which is demodulated (demodulated position) such that a next head position (demodulation position) in a next servo area 550 to which the head approaches next after the servo area comes to a desired head position.

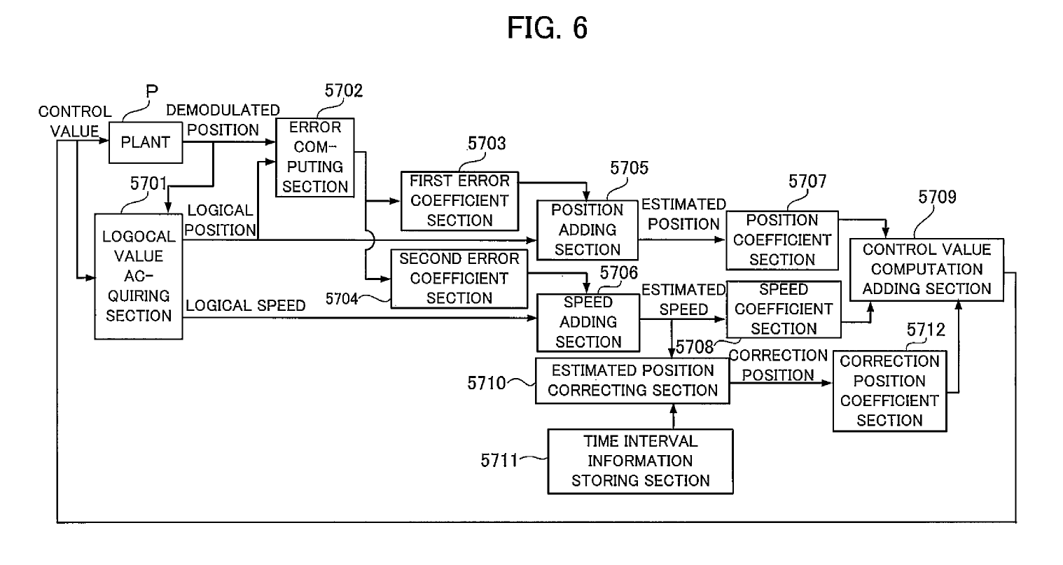

FIG. 6 is a control block diagram illustrating the head positioning control performed in the HDD 500 of FIG. 4.

In FIG. 6, the head 51 and the voice coil motor 54 of FIG. 4 are collectively indicated as a plant P, and in FIG. 6, the plant P is schematically illustrated as outputting a demodulated position in a dual manner when a control value (control current value) is inputted.

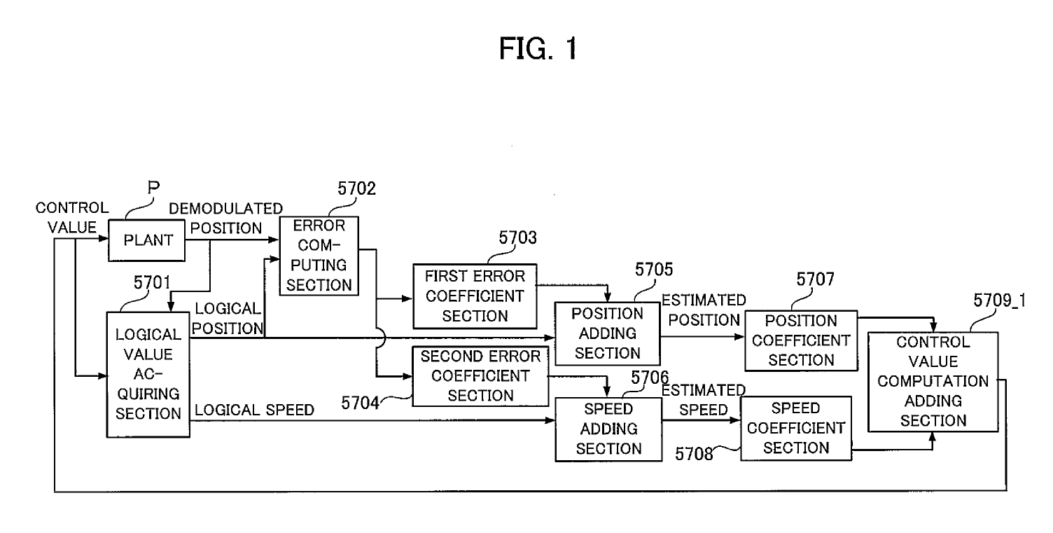

In FIG. 6, a logical value acquiring section 5701, an error computing section 5702, a first estimated error coefficient section 5703, a second estimated error coefficient section 5704, a position adding section 5705, a speed adding section 5706, a position coefficient section 5707, a speed coefficient section 5708, and a control value computation adding section 5709, an estimated position correcting section 5710, a time interval information storing section 5711, and a correction position coefficient section 5712 which carry an adjustment of the control value are illustrated. The sections correspond to functions included in the MPU 570 of FIG. 5 as hardware. Here, the logical value acquiring section 5701, the error computing section 5702, the first estimated error coefficient section 5703, the second estimated error coefficient section 5704, the position adding section 5705, the speed adding section 5706, the position coefficient section 5707, and the speed coefficient section 5708 perform the same operations as those sections which have the same numbers in FIG. 1, respectively. However, comparing to the block diagram in FIG. 1, the control block diagram of FIG. 6 is most largely different from that of FIG. 1 in that the estimated position correcting section 5710, the time interval information storing section 5711, and the correction position coefficient section 5712 are added.

A control value of the plant P is inputted to the logical value acquiring section 5701. Whenever demodulation of a position of the head is performed, a demodulated position is inputted to and stored in the logical value acquiring section 5701. When the control value of the plant P and the demodulated position under the control value are inputted, the logical value acquiring section 5701 reads a demodulated position of the head of one time before and a demodulated position of the head of two times before and computes an average head speed between demodulation of a head of two times before and demodulation of the head of one time before by dividing a difference between the demodulated position of the head of one time before and the demodulated position of the head of two times before by a predetermined time corresponding to a time interval of the demodulation operation of head position. Next, the logical value acquiring section 5701 approximately solves an equation of motion for a position of the head under the inputted control value, under a condition in which an initial position of the head with respect to the radial direction of the magnetic disc is a demodulated position of the head one time before, and an initial speed of the head with respect to the radial direction of the magnetic disc is the average speed described above. The logical value acquiring section 5701 computes a position of the head and a speed of the head after the above-described predetermined time lapses based on a result of solving the equation. The position of the head and the speed of the head thus computed are a logical position of the head (logical position) and a logical speed of the head (logical speed) in the servo area where the demodulated position is obtained this time.

The error computing section 5702 computes a difference (error) between the demodulated position outputted from the plant P and a logical position in the servo area where the demodulated position is obtained. The first error coefficient section 5703 and the second error coefficient section 5704 multiply errors computed by the error computing section 5702 by coefficients according to the error, respectively. What coefficients are to be multiplied according to error values are determined in advance in the first error coefficient section 5703 and the second error coefficient section 5704 in terms of approaching a position of the head to a desired position of the head position, and the “coefficients according to errors” are determined according to this determination.

The position adding section 5705 adds the error which is multiplied by the coefficient in the first error coefficient section 5703 to the logical position obtained in the logical value acquiring section 5701. Here, a value which is obtained in the position adding section 5705 is an estimated value (estimated position) of a position of the head in a servo area to which the head approaches next after the servo area to which demodulation of the position of the head is performed previously. The position coefficient section 5707 multiplies the estimated position by a predetermined coefficient.

The speed adding section 5706 adds the error multiplied by the coefficient in the second error coefficient section 5704 to the logical speed obtained in the logical value acquiring section 5701. Here, a value which is obtained in the speed adding section 5706 is an estimated value (estimated speed) of a speed of the head at a servo area to which the head approaches next after the servo area to which demodulation of the position of the head is performed previously. The speed coefficient section 5708 multiplies the estimated speed by a predetermined coefficient.

Generally, an equation of motion for a position of a head is a linear relational expression of a control value of the plant P (control current of the voice coil motor), a position of the head, a speed of the head, and an acceleration of the head, and becomes an equation in which the control value of the plant P is expressed by the position of the head and the speed of the head if the acceleration of the head is ignored.

The predetermined coefficient by which the estimated position of the head is multiplied in the position coefficient section 5707 and the predetermined coefficient by which the estimated speed of the head is multiplied in the speed coefficient section 5708 are a coefficient of the position of the head and a coefficient of the speed of the head in the equation that a control value of the plant P is expressed by a position of the head and a speed of the head.

The estimated position correcting section 5710, the time interval information storing section 5711, and the correction position coefficient section 5712 will be described in detail below.

In a case where the magnetic disc 50 is attached to the HDD 500 in a state in which that a central point of a disc of the magnetic disc 50 is shifted from a rotation center of the HDD 500, when the magnetic disc 50 rotates at a predetermined rotation speed (angle speed), the more the data sector 551 or the servo sector 550 is distant from the rotation center, the shorter a time in which the magnetic disc 50 passes a position of the head 51 is. As a result, in one track 55 (see FIG. 4) on the magnetic disc 50, a time interval (servo frame time interval) in which a servo mark is read becomes shorter than a normal servo frame time interval in the data sector 551 or the servo sector 550 which is distant from the rotation center, and becomes longer than a normal servo frame time interval in the data sector 551 or the servo sector 550 which is close to the rotation center.

In general, in order to read a servo signal including position information or a servo mark from the servo sector and lock the servo signal, it is required to estimate a timing when the servo sector passes the head. For this reason, a time interval information table that represents how much a servo frame time interval is deviated from a normal servo frame time interval for each sector 551 has been conventionally used in a HDD.

In the HDD 500 according to the embodiment, such time interval information table is used to lock a servo signal, and in the HDD 500, the time interval information table is used not only to lock a servo signal but also to position the head 51. The time interval information table is stored in the time interval information storing section 5711 in FIG. 6.

The estimated position correcting section 5710 determines how much a servo frame time interval between the servo area 550 to which demodulation of a position of the head is performed previously and the servo area 550 to which the head 51 approaches next is deviated from a normal servo frame time interval, with reference to time interval information in the time interval information storing section 5711. The deviation amount becomes a positive value if the servo frame time interval is smaller than the normal servo frame time interval and becomes a negative value if the servo frame time interval is larger than the normal servo frame time interval. Next, the estimated position correcting section 5710 multiplies the estimated speed obtained by the speed adding section 5706 by the deviation amount of the servo frame time interval. Here, the estimated position obtained by the position adding section 5705 is a position (estimated position) estimated in ignoring that there is the deviation in the servo frame time interval, and a value obtained in the estimated position correcting section 5710 by multiplying the estimated speed by the deviation amount of the servo frame time interval is a correction amount (correction position) in which the existence of the deviation of the servo frame time interval is factored in the estimated position.

The correction position coefficient section 5712 multiplies the correction position obtained in the estimated position correcting section 5710 by a predetermined coefficient which is identical the coefficient by which the position coefficient section 5707 multiplies the estimated position. Thus, a value obtained in the correction position coefficient section 5712 by multiplying the correction position by the predetermined coefficient is a correction amount for the value obtained in the position coefficient section 5707 by multiplying the estimated position by the predetermined coefficient.

The control value computation adding section 5709 in FIG. 6 determines a sum of the estimated value of the position of the head multiplied by the coefficient in the position coefficient section 5707, the estimated value of the speed of the head 51 multiplied by the coefficient in the speed coefficient section 5708, and the correction position multiplied by the coefficient in the correction position coefficient section 5712. The control value computation adding section 5709 in FIG. 6 is different from the control value computation adding section 5709 in FIG. 1 in that the correction position multiplied by the coefficient in the correction position coefficient section 5712 is added. A value of the sum obtained in the control value computation adding section 5709 in FIG. 6 is employed as a new control value for setting a position of the head (demodulated position) in a servo area to which the head 51 approaches next to a desired position of the head.

As described above, updating of the control value is repetitively performed, so that a position of the head gradually becomes closer to a desired position of the head.

Here, the estimated position correcting section 5710, the time interval information storing section 5711, the correction position coefficient section 5712, and the control value computation adding section 5709 collectively correspond to one example of the driving force correcting section in the basic aspect described above.

More specifically, in the equation of motion for a position of a head, there exists external forces which are not proportional to the position of the head or the speed of the head such as a force caused by an air flow generated as a magnetic disc rotates. Regarding such external forces, the magnitudes of the forces are determined in advance and are listed in a table. In a conventional HDD, influences of the external forces are eliminated by adjusting the control value with reference to the table. The control block diagram in FIG. 6 illustrates a method of adjusting the control value for positioning a head under an assumption that the influences of the external forces are eliminated and thus do not exist.

As described above, in the HDD 500, when a new control value is obtained, the correction position in which the estimated speed is multiplied by the deviation amount of the servo frame time interval is factored, so that the influence of the deviation of the servo frame time interval on the positioning accuracy of the head 51 is corrected. Therefore, in the HDD 500, an error between an actual position of the head (demodulated position) and a logical position of the head (logical position) can be readily small, so that head positioning is performed with high accuracy in a short time.

Next, another embodiment will be described.

The another embodiment also relates to a HDD in which a head positioning control is performed. The HDD according to this another embodiment is different from the HDD 500 of FIG. 5 in that when a new control value is obtained, a correction of an estimated speed according to a deviation of the servo frame time interval is added. Except for this point, the HDD according to the another embodiment is identical to the HDD 500 of FIG. 5. Hereinafter, the HDD according to the another embodiment will be described focusing different points.

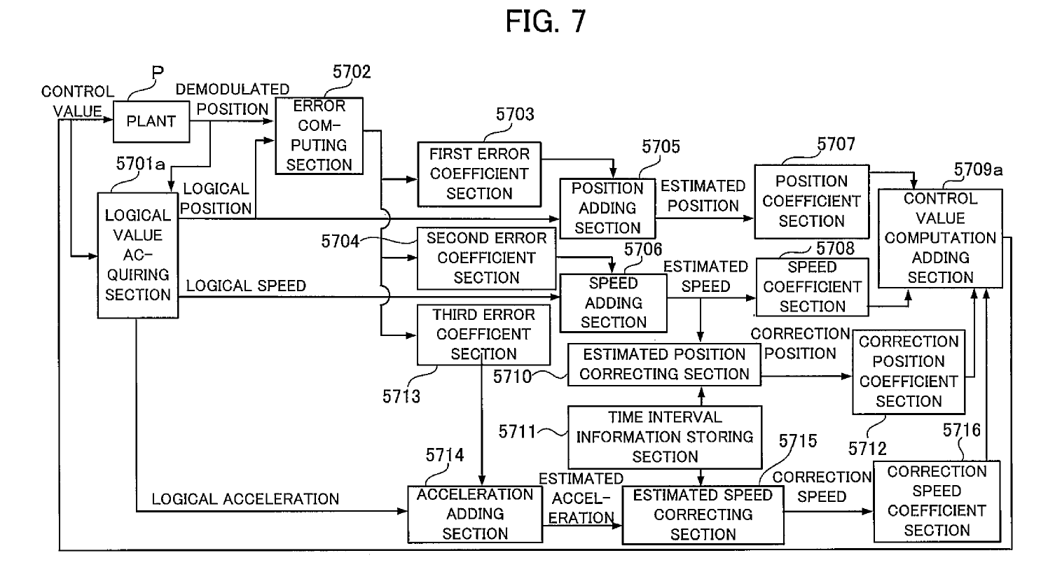

FIG. 7 is a control block diagram illustrating control of positioning a head to be performed in the HDD according to the another embodiment.

In FIG. 7, the same elements as those in FIG. 6 are denoted with the same references of those in FIG. 6, and thus duplicated descriptions on them will be omitted. Compared to the control block diagram of FIG. 6, the control block diagram of FIG. 7 is different mainly in that a logical value acquiring section 5710a acquires a logical acceleration, and a third error coefficient section 5713, an acceleration adding section 5714, an estimated speed correcting section 5715, and a correction speed coefficient section 5716 are provided. These sections correspond to functions included in the MPU 570 of FIG. 5 as hardware.

The logical value acquiring section 5701a of FIG. 7 determines a logical acceleration as well as a logical position and a logical speed of the head 51 as described in FIG. 6. Here, the logical acceleration is defined as an acceleration of the head with respect to a radial direction of the magnetic disc which acceleration is determined by the approximate equation of motion (the approximate equation of motion used to obtain a logical position and a logical speed of the head 51) for a position of the head under a control value inputted to the logical value acquiring section 5701a.

The third error coefficient section 5713 multiplies an error computed in the error computing section 5702 by a coefficient according to the error. Here, which coefficient is to be multiplied according to a value of the error is determined in advance in the third error coefficient section 5713 from a viewpoint of approaching a position of the head to a desired position of the head, and the above-described “coefficient according to an error” is determined according to this determination.

The acceleration adding section 5714 adds the error multiplied by the coefficient in the third error coefficient section 5713 to the logical acceleration obtained in the logical value acquiring section 5701. Here, a value obtained in the acceleration adding section 5714 is an estimated value of an acceleration (estimated acceleration) of the head 51 in a servo area that the head 51 approaches next after the position of the head 51 is demodulated previously.

The estimated speed correcting section 5715 determines how much a servo frame time interval between the servo area 550 to which demodulation of the position of the head is performed previously and the servo area 550 which the head 51 approaches next is deviated from the normal servo frame time interval, with reference to the time interval information in the time interval information storing section 5711. As described in FIG. 6, an amount of the deviation above becomes a positive value if the servo frame time interval is smaller than the normal servo frame time interval, and becomes a negative value if the servo frame time interval is larger than the normal servo frame time interval. Next, the estimated speed correcting section 5715 multiplies the estimation speed obtained by the acceleration adding section 5714 by the amount of the deviation of the servo frame time interval. Here, the estimated speed obtained in the speed adding section 5706 is a speed (estimated speed) estimated neglecting that there is the deviation in the servo frame time interval, and the value obtained by multiplying the estimate acceleration by the amount of deviation of the servo frame time interval in the estimation speed correcting section 5715 is a correction amount (correction speed) in which the existence of the deviation of the servo frame time interval is factored for the estimated speed.

The correction speed coefficient section 5716 multiplies the correction speed obtained in the estimated speed correcting section 5715 by a predetermined coefficient same as the coefficient by which the speed coefficient section 5708 multiplies the estimated speed. Thus, the value obtained by multiplying the correction speed by the above-described predetermined coefficient in the correction speed coefficient section 5716 is a correction amount with respect to a value obtained by multiplying the estimated speed by the predetermined coefficient in the speed coefficient section 5708.

The control value computation adding section 5709a in FIG. 7 determines a sum of the estimated value of the position of the head multiplied by the coefficient in the position coefficient section 5707, the estimated value of the speed of the head 51 multiplied by the coefficient in the speed coefficient section 5708, the correction position multiplied by the coefficient in the correction position coefficient section 5712, and the correction speed multiplied by the coefficient in the correction speed coefficient section 5716. The control value computation adding section 5709a of FIG. 7 is different from the control value computation adding section 5709 of FIG. 6 in that the correction speed multiplied by the coefficient in the correction speed coefficient section 5716 is added. A value of the sum obtained in the control value computation adding section 5709a of FIG. 7 is employed as a new control value for setting a position of the head (demodulated position) in the servo area which the head 51 approaches next to a desired position of the head. Here, the estimated acceleration is used to obtain the correction speed for correcting the deviation of the servo frame time interval, and when a new control value is determined, a contribution of the estimated acceleration corresponding to the equation of motion of the head is neglected, however in the control value computation adding section 5709, the contribution of the estimated acceleration corresponding to the equation of motion of the head may be added.

As described above, in the HDD 500, when a new control value is obtained, not only the correction position is factored as described above in FIG. 6, but also the correction speed that the estimated acceleration multiplied by the deviation of the servo frame time interval is factored, so that the effect of correcting the influence of the deviation of the servo frame time interval of the magnetic disc 55 is improved. Therefore, in the HDD 500 according to the another embodiment, an error between the actual position of the head (demodulated position) and the logical position of the head (logical position) can be readily small, so that the head positioning is performed with high accuracy in a short time.

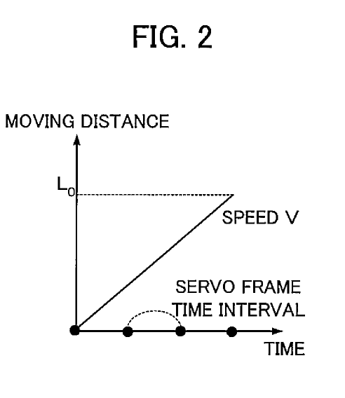

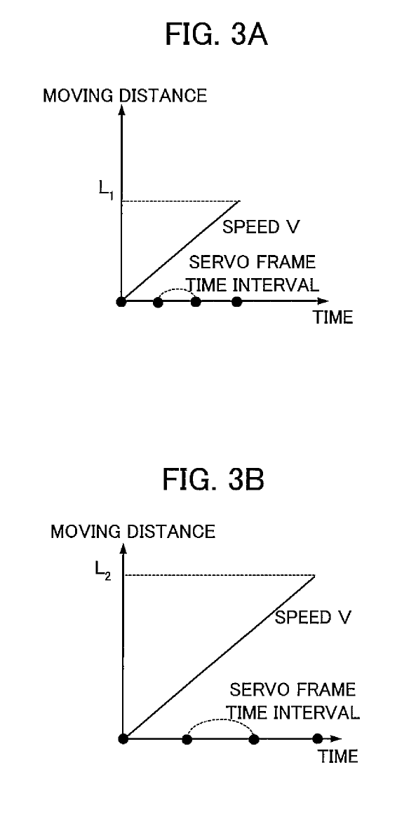

Next, the effect of the control in which the influence of the deviation of the servo frame time interval is corrected will be described using a moving distance of the head described in FIGS. 2 and 3 as an example.

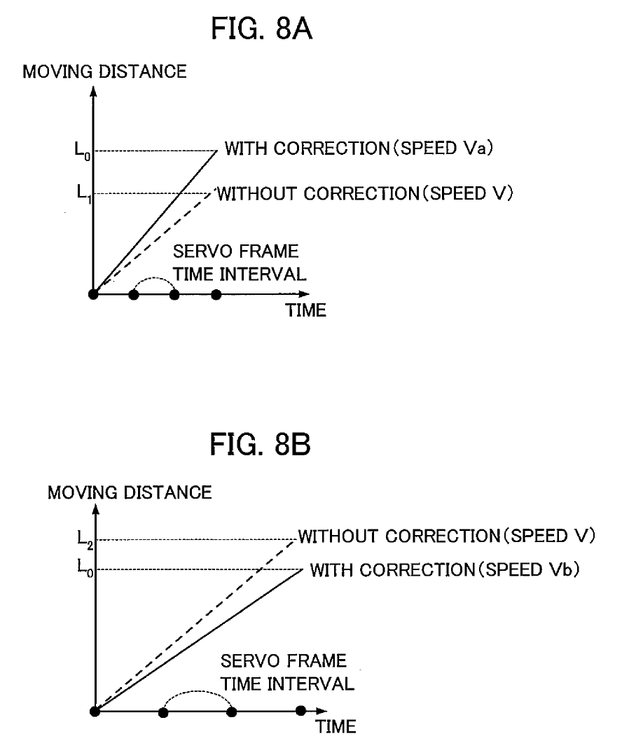

FIGS. 8A and 8B illustrate moving distances of the head in a situation where the servo frame time interval is deviated from the normal frame time interval in the HDD according to the another embodiment.

FIGS. 8A and 8B illustrate a change of a distance in which the head moves while the head encounters a predetermined number (in this example, four) in a situation in which the head moves relatively to the magnetic disc at a predetermined speed V in the HDD according to another embodiment. Here, in FIG. 8A, the change of the moving distance of the head at a place where the servo frame time interval is smaller than the normal servo frame time interval in a magnetic disc is indicated by a solid line, and in FIG. 38, the change of the moving distance of the head at a place where the servo frame time interval is larger than the normal servo frame time interval is indicated by a solid line. Also, for comparison, in FIGS. 8A and 8B, the changes of the moving distances of the head in the conventional HDD described in FIGS. 3A and 3B are indicated by a dotted line. These changes of the moving distances of the head indicated by the dotted line are identical to those illustrated in FIGS. 3A and 3B.

In the HDD according to the another embodiment, as described above, when a new control value is obtained, the new control value is determined in consideration of the deviation of the servo frame time interval. Therefore, when the servo frame time interval is smaller than the normal servo frame time interval, as illustrated in FIG. 8A, the speed of the head changes to a speed Va larger than the speed V, and when the servo frame time interval is larger than the normal servo frame time interval, as illustrated in FIG. 8B, the speed of the head changes to a speed Vb smaller than the speed V. Here, the speed Va is a speed required for the head to move the same moving distance as the moving distance L₀ of when the servo frame time interval is normal as illustrated in FIGS. 3A and 3B even though the servo frame time interval is small as illustrated in FIG. 8A. The speed Vb is a speed required for the head to move the same moving distance as the moving distance L₀ even though the servo frame time interval is large as illustrated in FIG. 8B. In the HDD according to the another embodiment, as described above, even though the servo frame time interval is deviated from the normal value, determination of the control value is performed so that the influence is corrected.

Next, the effect of the control described above in which the influence of the deviation of the servo frame time interval is corrected will be described using an experimental result.

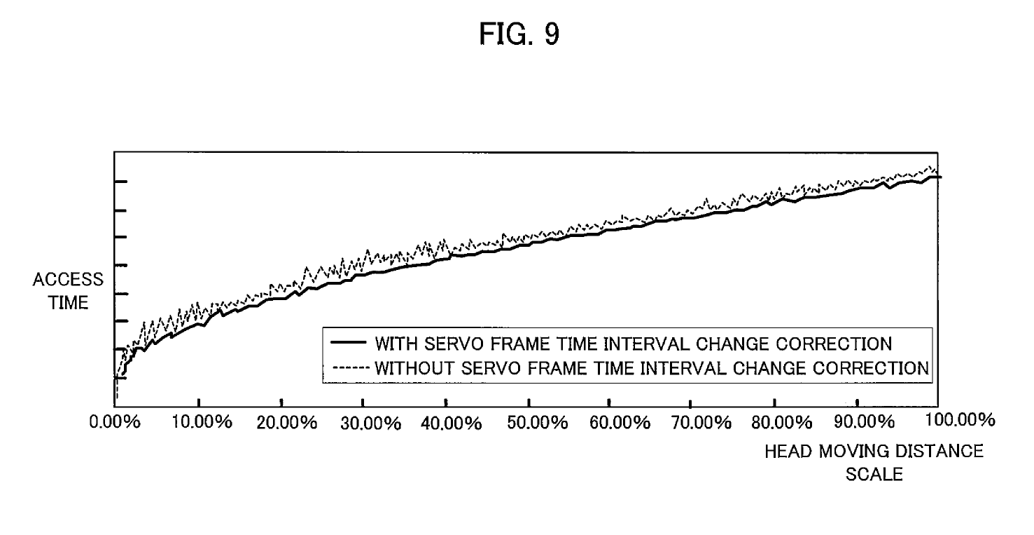

FIG. 9 illustrates an access time when the control of correcting the influence of the deviation of the servo frame time interval is performed and an access time when such control is not performed.

Here, the access time is a time represented by a sum of a time (seek time) required for positioning a head to a desired position with respect to a radial direction of a magnetic disc, a time (search time) required for the head to reach a desired position with respect to the circumferential direction of the magnetic disc as the magnetic disc rotates, and a time (data transfer time) required to record/reproduce data.

FIG. 9 is a graph illustrating results of the access time when an experiment in which the head is positioned to a target position with respect to the radial direction of the magnetic disc and a predetermined amount of data is recorded at a predetermined position with respect to the circumferential direction of the magnetic disc is performed while changing the target position described above. The solid line graph is a graph when the control in which the influence of the deviation of the servo frame time interval is corrected is performed, and the dotted line graph is a graph when the control is not performed. In FIG. 9, the target position is expressed at a rate (unit is percentage) with the radius of the magnetic disc as reference. Here, as the target position is changed, since the search time and the transfer time can be regarded as being hardly changed, the change of the access time substantially corresponds to the change of the seek time.

As illustrated in FIG. 9, the graph when the control of correcting the influence of the deviation of the servo frame time interval is performed is located lower than the graph when the control is not performed. From this point, it can be understood that control of correcting the influence of the deviation of the servo frame time interval is performed, so that the time required for positioning the head to the target position is reduced. Also, the graph when control of correcting the influence of the deviation of the servo frame time interval is performed has a fluctuation in the up-and-down direction in FIG. 9, smaller than that of the graph when the control is not performed. Accordingly, it can be understood that the stability is in proved to be higher when the target position is changed.

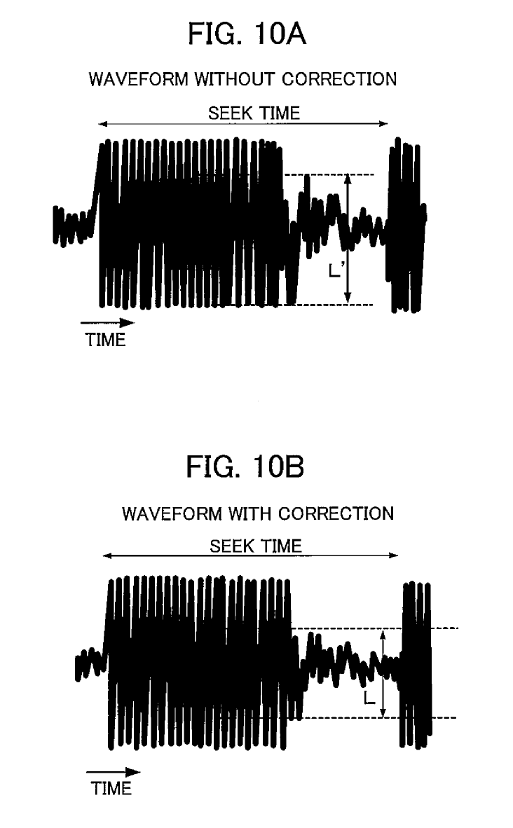

FIGS. 10A and 10B illustrate the changes along time of the position of the head while positioning of the head is performed (during the seek time).

FIG. 10A illustrates the change along time of the position of the head when positioning the head is performed under control in which the deviation of the servo frame time interval is corrected, and FIG. 10B illustrates the change along time of the position of the head when positioning of the head is performed without performing the control.

As illustrated in FIGS. 10A and 10B, it is noted that in the first part of the seek time, when the control of correcting the deviation of the servo frame time interval is performed, and also when the control is not performed, the position of the head intensely swings, and the swing gradually settles down in the latter part of the seek time. With respect to the maximum value of the swing amplitude when the swing gradually settles down in the latter part of the seek time, the maximum value L of the swing amplitude in FIG. 10B when the control of correcting the deviation of the servo frame time interval is performed is smaller than the maximum value L′ of the swing amplitude of FIG. 10A when the control of correcting the deviation of the servo frame time interval is not performed. From this point, it can be understood that the convergence until the head is positioned to the target position is improved by performing the control of correcting the deviation of the servo frame time interval.

Hereinbefore, the embodiments have been described.

As described above, a new control value is determined as a linear sum of respective values of the estimated position, the estimated speed and the estimated acceleration. However, in the basic aspect described above, the control value may include non-linear contributions of the respective values when a new control value is determined in order to approach the control value to an appropriate control value such that a position of the head comes to a desired position.

A preferred aspect for the basic aspect will be described below based on the two embodiments described above.

In the basic aspect described above, it is preferable that the recording medium is a recording medium in which a plurality of control marks aligned in a rule that an angle interval viewed from a center of the disc is constant are recorded as the plurality of control marks.

According to such aspect, the detection interval of the control mark when the recording medium rotates can be readily constant. In the two embodiments, as described above, the multiple servo areas 550 of the magnetic disc 50 in FIG. 4 are formed on the magnetic disc 50 such that the angle interval viewed from the rotation center of the magnetic disc 50 is as constant as possible, and the preferable aspect is obtained.

Also, in the preferable aspect described above, it is further preferable that the recording medium is a recording medium in which position information is recorded at each of spots on the recording medium, the position information representing each of the spots respectively, and the head also reads the position information, wherein the information storage apparatus further includes: a position estimating section that estimates a current position of the head based on the control of the driving force for the head driving section up to the current time; and a position identifying section that identifies an actual current position of the head by reading the position information through the head, wherein the driving force control section controls the driving force for the head driving section based on a difference between the current position estimated in the position estimating section and the current position identified in the position identifying section.

According to such aspect, the driving force is controlled based on a difference between the estimated current position and the current position identified in the position identifying section described above, so that it is possible to position the head with high accuracy reflecting an actual head position. Here, in the two embodiments described above, the logical value acquiring section 5701a, the error computing section 5702, the first effort coefficient section 5703, and the position adding section 5705 in FIGS. 6 and 7 collectively correspond to one example of the position estimating section, and the error computing section in FIGS. 6 and 7 to which the demodulated position of the head 51 is inputted corresponds one example of the position identifying section. In addition, in the two embodiments described above, the control of the voice coil motor 54 is performed by the MPU 570 which corresponds to one example of the driving force control section based on a difference (error) between the demodulated position outputted from the plant P in FIGS. 6 and 7 and the logical position of the servo area for which the demodulated position is obtained. Therefore, in the two embodiments described above, the preferable embodiment that the head performs also reading of the position information is obtained.

In addition, in the preferable aspect in which the head performs also reading of the position information, it is a further preferable that the information storage apparatus further includes a speed estimating section that estimates a current speed of the head based on the control of the driving force for the head driving section up to the current time, wherein the driving force correcting section corrects the driving force controlled by the driving force control section by a correction amount which is in proportion to a product of the current speed estimated in the speed estimating section and the difference.

According to such embodiment, a correction amount for a shift of a position of the head is obtained by multiplying the estimated speed by the deviation of the detection interval of the control mark. The influence of the deviation of the detection interval of the control mark is effectively corrected by performing the control based on the correction amount. Here, in the two embodiments described above, the influence of the deviation of the servo frame time interval for the positioning accuracy of the head 51 is corrected by factoring the correction position that the estimated speed is multiplied by the deviation of the detection interval of the control mark. Therefore, in the two embodiments described above, the preferable aspect, including the speed estimating section, is obtained.

In the preferable aspect in which the head performs also reading of the position information, it is a furthermore preferable that that the information storage apparatus further includes a speed estimating section that estimates a current speed of the head based on the control of the driving force up to the current time for the head driving section and an acceleration estimating section that estimates a current acceleration of the head based on the control of the driving force up to the current time for the head driving section, wherein the driving force correcting section corrects the driving force controlled by the driving force control section by both a first correction amount which is in proportion to a product of the current speed estimated in the speed estimating section and the difference and a second correction amount which is in proportion to a product of the current acceleration estimated in the acceleration estimating section and the difference.

According to such embodiment, a correction amount for a shift of a position of the head is obtained by multiplying the estimated speed by the deviation of the detection interval of the control mark, and a correction amount for a shift of a speed of the head is obtained by multiplying the estimated acceleration by the deviation of the detection interval of the control mark. The influence of the deviation of the detection interval of the control mark is highly effectively corrected by performing the control based on these correction amounts. Here, in the two embodiments described above, the influence of the deviation of the servo frame time interval for the positioning accuracy of the head 51 is corrected by factoring the correction position that the estimated speed is multiplied by the deviation of the servo frame time interval and the correction speed that the estimated acceleration is multiplied by the deviation of the servo frame time interval when the control value is determined. Therefore, in the two embodiments described above, the preferable aspect including the acceleration estimating section is obtained.

According to the basic aspect of the present invention, in control mark detection, even though an actual detection interval (actual detection time interval) deviates from an ideal detection interval (ideal detection time interval), a control value of driving force of a head is corrected based on a difference between the actual detection interval and the ideal detection interval. As a result, an influence of deviation in the detection interval of the control mark for an head positioning accuracy is corrected. Therefore, in the basic aspect of the present invention, head position determination with high accuracy is realized.

As described above, the information storage apparatus according to the basic aspect of the present invention can perform head positioning with high accuracy in a short time.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has (have) been described in detail, it should be understood that the various changes, substitutions, and alterations could be made hereto without departing from the spirit and scope of the invention.

What is claimed is:

1. An information storage apparatus, comprising:
a recording medium which has a disc shape and in which information is recorded and a plurality of control marks are recorded, the plurality of control marks being aligned in a predetermined rule;
a medium driving section that rotates the recording medium;
ahead that contacts or approaches a surface of the recording medium to perform reproducing of information and/or recording of information from/to the recording medium and that detects the a plurality of control marks;
a head driving section that holds the head and moves the head along the surface of the recording medium in a direction including a directional component of coming near or coming away to/from a rotation center of the recording medium;
a driving force control section that controls a driving force for the head driving section;
a driving time control section that controls a driving time for the head driving section using as a unit of time an interval of the detection of the plurality control marks by the head as the recording medium is rotated by the medium driving section; and
a driving force correcting section that obtains a difference between an ideal interval of the control mark based on the rule and an actual interval of the control mark, and that corrects the control of the driving force controlled by the driving force control section based on the difference.

2. The information storage apparatus according to claim 1, wherein the recording medium is a recording medium in which a plurality of control marks aligned in a rule that an angle interval viewed from a center of the disc is constant are recorded as the plurality of control marks.

3. The information storage apparatus according to claim 2,
wherein the recording medium is a recording medium in which position information is recorded at each of spots on the recording medium, the position information representing each of the spots respectively, and
the head also reads the position information,
wherein the information storage apparatus further comprises:
a position estimating section that estimates a current position of the head based on the control of the driving force for the head driving section up to the current time; and
a position identifying section that identifies an actual current position of the head by reading the position information through the head,
wherein the driving force control section controls the driving force for the head driving section based on a difference between the current position estimated in the position estimating section and the current position identified in the position identifying section.

4. The information storage apparatus according to claim 3, further comprising,
a speed estimating section that estimates a current speed of the head based on the control of the driving force for the head driving section up to the current time,
wherein the driving force correcting section corrects the driving force controlled by the driving force control section by a correction amount which is in proportion to a product of the current speed estimated in the speed estimating section and the difference.

5. The information storage apparatus according to claim 3, further comprising,
a speed estimating section that estimates a current speed of the head based on the control of the driving force up to the current time for the head driving section; and
an acceleration estimating section that estimates a current acceleration of the head based on the control of the driving force up to the current time for the head driving section,
wherein the driving force correcting section corrects the driving force controlled by the driving force control section by both a first correction amount which is in proportion to a product of the current speed estimated in the speed estimating section and the difference and a second correction amount which is in proportion to a product of the current acceleration estimated in the acceleration estimating section and the difference.
